(19) United States
(12) Patent Application Publication
(10) Pub. No.: US 2006/0095753 A1
(43) Pub. Date: May 4, 2006

(54) Information processing apparatus and boot control method

(75) Inventor: Shuji Hori, Iruma-shi (JP)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: KABUSHIKI KAISHA TOSHIBA

(21) Appl. No.: 11/219,812

(22) Filed: Sep. 7, 2005

(30) Foreign Application Priority Data
Oct. 29, 2004 (JP) 2004-316515

(51) Int. Cl. G06F 9/00

(52) U.S. Cl. 713/1

(57) ABSTRACT

An information processing apparatus includes a main body, an input device that is provided on the main body and inputs input data that designates one of a plurality of boot devices, a reproduction unit that reproduces data for identifying the boot device that is designated by the input data, and a unit that executes a process for booting up an operating system from the boot device that is designated by the input data.

### CROSS-REFERENCE TO RELATED APPLICATIONS

This application is based upon and claims the benefit of priority from prior Japanese Patent Application No. 2004-316515, filed Oct. 29, 2004, the entire contents of which are incorporated herein by reference.

### BACKGROUND

1. Field

The present invention relates to an information processing apparatus such as a personal computer, and to a boot control method for use in the information processing apparatus.

2. Description of the Related Art

In general, a personal computer is provided with a plurality of boot devices. Jpn. Pat. Appln. KOKAI Publication No. 2002-215399, for instance, discloses a computer system in which an operating system is booted up from one with highest priority of a plurality of boot devices such as a flexible disk drive, a hard disk drive and a CD-ROM (Compact Disc Read Only Memory) drive.

Recently, a personal computer, which has a function of selecting one of boot devices in accordance with an operation of an input device such as a keyboard, has been developed.

The conventional personal computer, however, is not provided with a function of informing the user as to from which boot device the operating system is to be booted up.

For example, even if the operating system is booted up from a boot device, which is not the intended device, due to an error in the key input operation by the user, the user is not aware of this situation. It is thus necessary to realize a function for informing the user as to from which boot device the operating system is to be booted up.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a perspective view that shows an external appearance of a computer according to an embodiment of the present invention;

FIG. 2 is a block diagram of a system configuration of the computer shown in FIG. 1;

FIG. 3 shows an example of assigned information that is used in the computer shown in FIG. 1;

FIG. 4 is a flow chart for explaining a process procedure of a boot-up process that is executed by the computer shown in FIG. 1;

FIG. 5 is a flow chart for explaining a process procedure at a time of boot-up of a main operating system, which is executed by the computer shown in FIG. 1;

FIG. 6 is a flow chart for explaining a process procedure at a time of boot-up of a sub-operating system, which is executed by the computer shown in FIG. 1;

FIG. 7 is a flow chart for explaining a process procedure at a time of activating a setup function, which is executed by the computer shown in FIG. 1;

FIG. 8 is a flow chart for explaining a process procedure at a time of activating a password check function, which is executed by the computer shown in FIG. 1;

FIG. 9 illustrates a state in which motion video data for identifying a hard disk drive, which is provided in the computer shown in FIG. 1, is reproduced; and

FIG. 10 illustrates a state in which motion video data for identifying an optical disk drive, which is provided in the computer shown in FIG. 1, is reproduced.

### DETAILED DESCRIPTION OF THE INVENTION

Embodiments of the present invention will now be described with reference to the accompanying drawings.

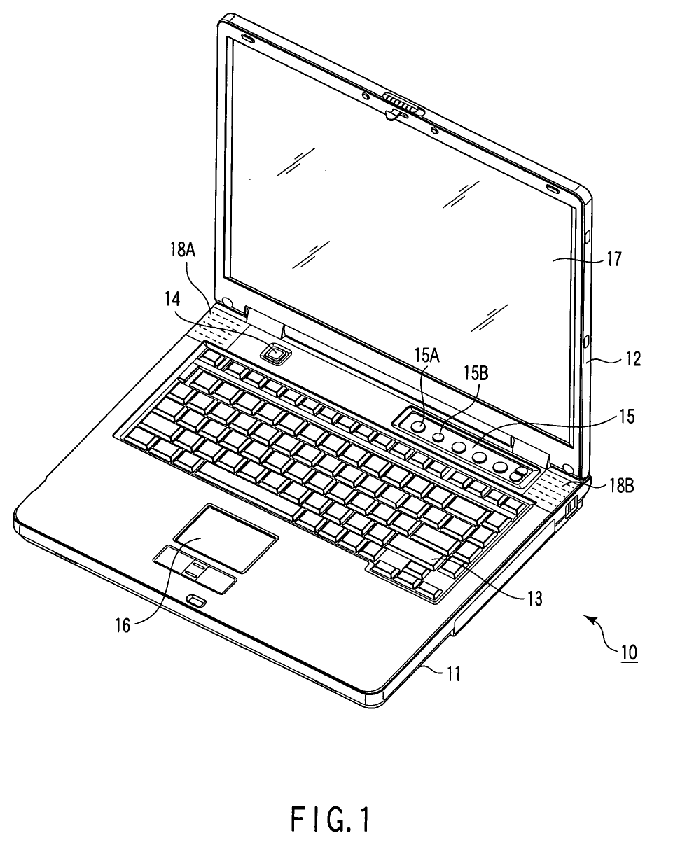

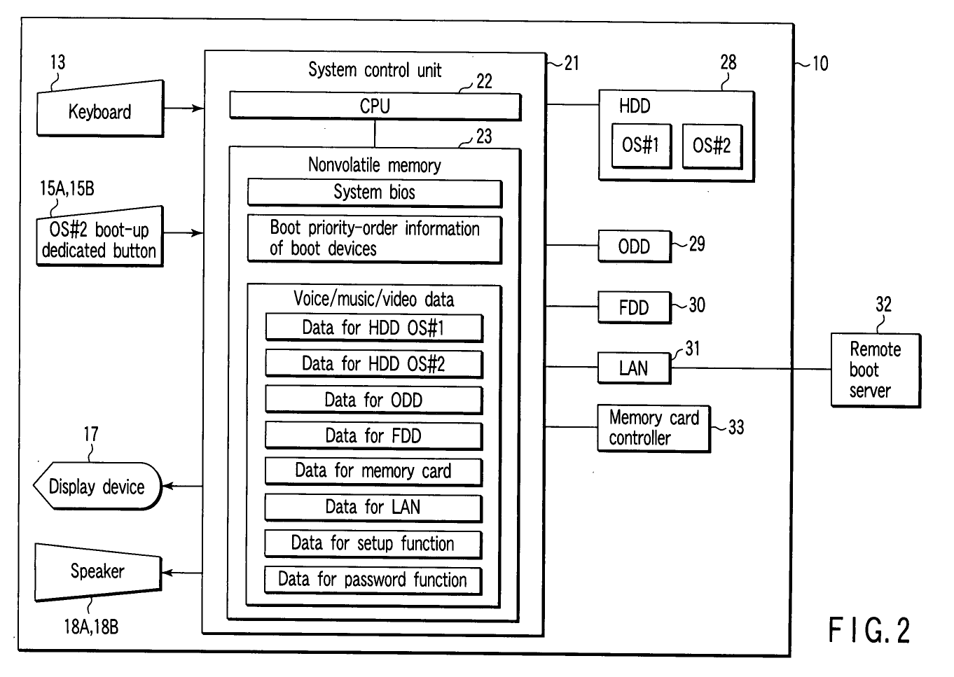

Referring to FIG. 1 and FIG. 2, the structure of an information processing apparatus according to an embodiment of the invention is described. The information processing apparatus is realized, for example, as a battery-powerable notebook personal computer 10.

FIG. 1 is a perspective view that shows the state in which a display unit of the personal computer 10 is opened. The computer 10 comprises a computer main body 11 and a display unit 12. A display device that is composed of an LCD (Liquid Crystal Display) 17 is built in the display unit 12. The display screen of the LCD 17 is positioned at an approximately central part of the display unit 12.

The display unit 12 is attached to the computer main body 11 such that the display unit 12 is freely rotatable between an open position and a closed position. The computer main body 11 has a thin box-shaped casing. A keyboard 13, a power button 14 for powering on/off the computer 10, an input operation panel 15, a touch pad 16, and speakers 18A, 18B for outputting reproduced audio data are disposed on the top surface of the computer main body 11.

The input operation panel 15 is an input device that inputs an event corresponding to a pressed button. The input operation panel 15 has a plurality of buttons for activating a plurality of functions. The buttons include a TV activation button 15A and a DVD (Digital Versatile Disc)/CD (Compact Disc) activation button 15B. The TV activation button 15A is a button for activating a TV function for reproducing and recording TV broadcast program data. When the TV activation button 15A is pressed by the user, a TV application program for executing the TV function is automatically started.

In this computer 10, a general-purpose main operating system (OS#1) and a purpose-specific sub-operating system (OS#2) for processing AV (audio/video) data are installed. The TV application program is a program that runs on the sub-operating system.

When the power button 14 is pressed by the user, the main operating system is booted up. On the other hand, when the TV activation button 15A is pressed by the user, the sub-operating system, and not the main operating system, is booted up, and the TV application program is automatically executed. The sub-operating system has only a minimum function for executing the AV function. The time that is needed to boot up the sub-operating system is much shorter than the time that is needed to boot up the main operating system. Thus, only by pressing the TV activation button 15A, the user can immediately execute TV viewing/recording.

The DVD/CD activation button 15B is a button for reproducing video content that is recorded on DVD media or CD media. When the DVD/CD activation button 15B is pressed by the user, a video reproduction application program for reproducing video content is automatically started. The video reproduction application program, too, is an application program that runs on the sub-operating system. When the DVD/CD activation button 15B is pressed by the user, the sub-operating system, and not the main operating system, is booted up, and the video reproduction application program is automatically executed.

The TV activation button 15A and DVD/CD activation button 15B function as a sub-operating system boot-up dedicated button (OS#2 boot-up dedicated button).

Referring now to FIG. 2, a system configuration of the computer 10 is described.

The computer 10 includes, in addition to the above-described keyboard 13, OS#2 boot-up dedicated buttons 15A, 15B, display device 17 and speakers 18A, 18B, a system control unit 21, a hard disk drive (HDD) 28, an optical disc drive (ODD) 29, a flexible disk drive (FDD) 30, a LAN (Local Area Network) controller 31 and a memory card controller 33. The hard disk drive (HDD) 28, optical disc drive (ODD) 29, flexible disk drive (FDD) 30, LAN controller 31 and memory card controller 33 function as boot devices (also known as bootable devices) for booting up operating systems.

The system control unit 21 includes a CPU 22 and a nonvolatile memory 23. The CPU 22 is a processor that controls the operation of the computer 10 and executes an operating system and various application programs. The CPU 22 also executes a system BIOS (Basic Input/Output System) that is stored in the nonvolatile memory 23. The system BIOS is a program for hardware control, and executes a POST (power-on self test) process and a boot process for booting up operating systems. The system BIOS has a function of reproducing content data for identifying a boot device from which the operating system is to be booted up, while the POST process is being executed. This content data reproducing function is used in order to inform the user as to from which boot device the operating device is to be booted up.

When the computer 10 is powered on by the user's operation of the power button 14, the system BIOS executes the POST process. If a specified key input is made from the keyboard 13 during the POST process, the system BIOS ignores boot priority-order information, and attempts to boot up the operating system from the boot device that is designated by the key input.

For example, key input data “1” designates the HDD 28, key input data “C” designates the ODD 29, key input data “F” designates the FDD 30, key input data “N” designates the LAN controller 31, and key input data “M” designates the memory card controller 33.

As mentioned above, two OS's (OS#1, OS #2) are installed in the HDD 28. The partition in which OS#1 is installed and the partition in which OS#2 is installed function as boot devices, respectively. Bootable media can be loaded in the ODD 29, FDD 30 and memory card controller 33. The LAN controller 31 is connected to a remote boot server 32.

The nonvolatile memory 23 that is built in the system control unit 21 stores content data (data for HDD OS#1, data for HDD OS#2, data for ODD, data for FDD, data for LAN and data for memory card) that are associated with the individual boot devices such as HDD 28, ODD 29, FDD 30, LAN controller 31 and memory card controller 33. Each content data includes at least one of audio data (voice data/music data) and video data (still image data/motion video data) In some cases, when the computer 10 is powered on, specific functions (setup function, password check function) that are provided by the system BIOS may be executed. For this purpose, the nonvolatile memory 23 stores content data (data for setup function, data for password check function) that are associated with the respective BIOS functions (setup function, password check function). The content data that are stored in the nonvolatile memory 23 can arbitrarily be set/changed by the user. The content data may be stored not in the nonvolatile memory 23, but in the HDD 28.

The nonvolatile memory 23 also stores assigned information that represents the correspondency between the respective boot devices/BIOS functions and the content data. The assigned information, too, can arbitrarily be set/changed by the user. The assigned information may be stored not in the nonvolatile memory 23, but in the HDD 28.

Further, the nonvolatile memory 23 stores the above-mentioned boot priority-order information that represents the order of priority of boot-up between the boot devices. The boot priority-order information can also be rewritten, and the boot priority-order can arbitrarily be set/changed by the user.

In the case where the HDD 28 is set as the highest-priority boot device by the boot priority-order information, if the user presses the power button 14, the OS#1 that is installed in the HDD 28 is booted up.

If the OS#2 boot-up dedicated button 15A, 15B is pressed by the user, the boot priority-order information is ignored, and the OS#2 that is installed in the HDD 28 is booted up.

The system BIOS has the above-mentioned setup function and password check function as inherent functions of the system BIOS that are executable without operating systems. The setup function is a function for displaying various setup information, which is stored in the nonvolatile memory 23, on the LCD 17, and enabling the user to change/store various setup information on an as needed basis. The setup function is activated, for example, when the user presses the power button 14 while pressing the “Esc” key. The setup function is also activated when there is abnormality in various setup information that is stored in the nonvolatile memory 23 and the system BIOS detects the abnormality in the setup information during the POST process.

The password check function is a function for displaying, on the LCD 17, a screen for prompting the user to input the password when the user has pressed the power button 14, and collating the input password with the registered password stored in the computer 10. Unless the input password and the registered password coincide, boot-up of the operating system and activation of the setup function are prohibited. The password check function is executed in the case where the password has been registered in the computer 10.

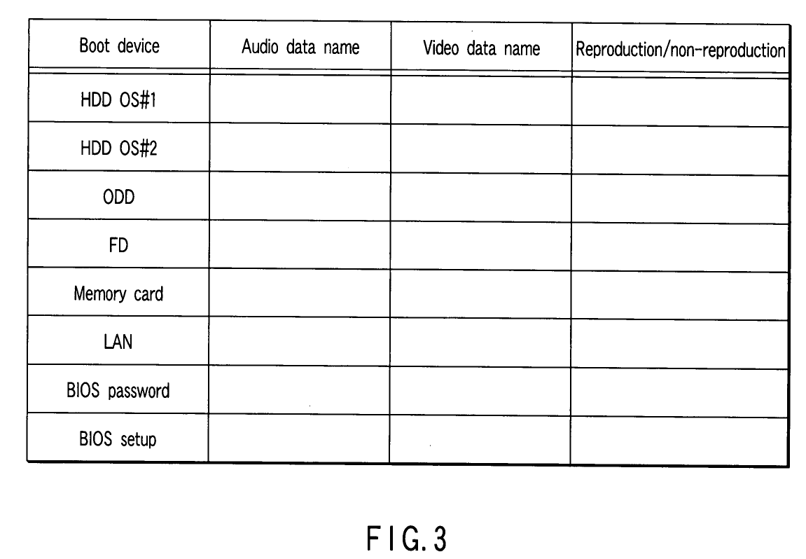

FIG. 3 shows an example of the above-mentioned assigned information.

In the assigned information, content data names (audio data names, video data names) and flags that designate effective/non-effective states of content data reproduction functions are managed in association with the boot devices (HDD OS#1, HDD OS#2, ODD, FD, memory card, LAN) and BIOS functions (BIOS password, BIOS setup). The content data names are, for instance, file names of audio/video data, path information, etc.

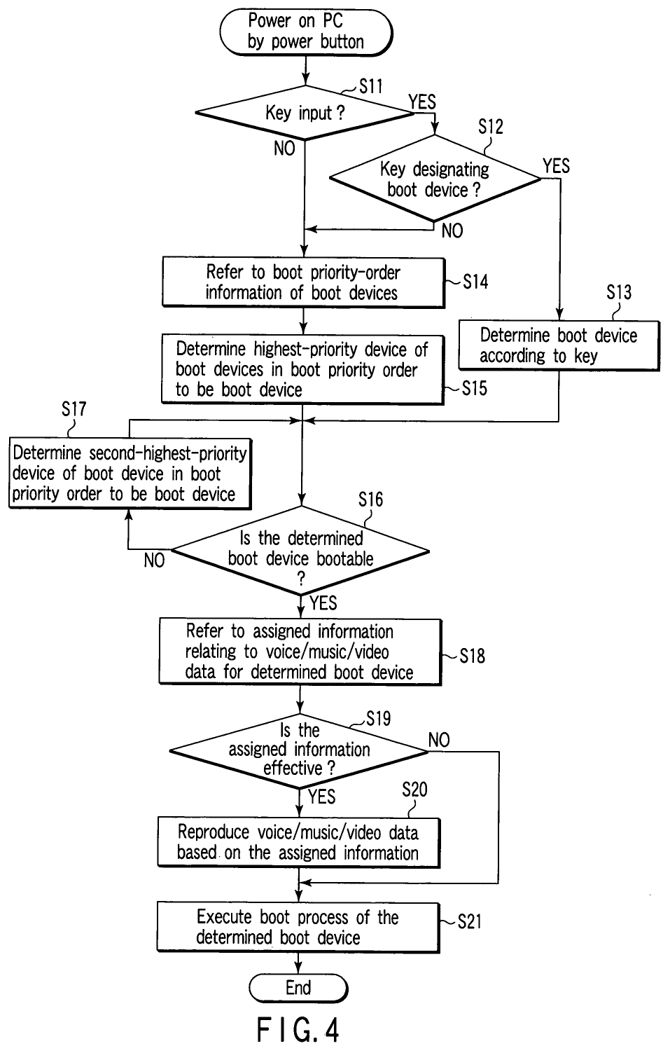

Next, with reference to a flow chart of FIG. 4, a series of process procedures, which are executed by the system BIOS, are described.

If the user presses the power button 14 to power on the computer 10, the system BIOS starts the POST process and checks, during the POST process, the presence/absence of a key input that directly designates the boot device (steps S11 and S12). If the key input that directly designates the boot device is absent (NO in step S11, or NO in step S12), the system BIOS determines the boot device with the highest priority to be the boot device that is used, in accordance with the boot priority-order information stored in the nonvolatile memory 23, and confirms whether the operating system can be booted up from the determined boot device (steps S14 to S16). If the operating system is not stored in the determined boot device, the system BIOS determines that the determined boot device is the device that cannot boot up the operating system.

On the other hand, if the key input that directly designates the boot device is made (YES in step S12), the system BIOS confirms whether the operating system can be booted up from the boot device that is designated by the key input (step S13, S16).

If the boot device, which is checked by the system BIOS, is not bootable (NO in step S16), the system BIOS refers to the boot priority-order information and determines the next boot device (step S16).

If the boot device, which is confirmed by the system BIOS, is bootable (YES in step S16), the system BIOS refers to the flag of the assigned information, and determines whether the assigned information, which corresponds to the boot device that is determined to be bootable, is effective or not, that is, whether the reproduction function of the content data corresponding to the boot device is effective or not (step S18, S19).

If the reproduction function is effective (YES in step S19), the system BIOS reproduces the content data corresponding to the boot device, which is designated by the assigned information (step S20). The content data, which is to be used, is, for instance, audio data including a voice message reading the name of the boot device aloud, image data including a character string corresponding to the name of the boot device, or music data including a specified melody.

If the reproduction function is non-effective (NO in step S19), the process in step S20 is skipped.

Thereafter, the system BIOS executes the boot process for booting up the operating system from the boot device that has been determined to be bootable (step S21).

As has been described above, by reproducing image data or audio data that identifies the boot device, it is possible to inform a person with hearing impairment or visual impairment as to from which boot device the operating system is to be booted up. In this case, the content data is reproduced during the POST process, prior to the actual boot-up of the operating system. The POST process is a process that is immediately executed in response to power-on of the computer 10. Thus, even without the user waiting for actual boot-up of the operating system, the user can confirm from which boot device the operating system is to be booted up.

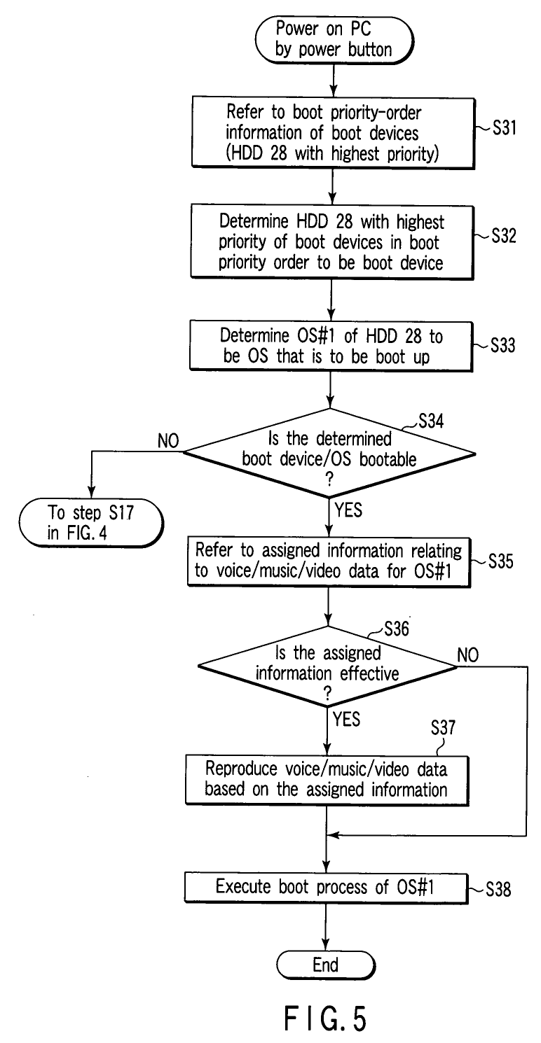

Next, referring to a flow chart of FIG. 5, a process procedure corresponding to the case where OS#1 is booted up is described.

Assume now that the user has pressed the power button 14 alone, without key input, and that the HDD 28 (specifically, the partition in HDD 28 that is associated with OS#1) is designated as the highest-priority boot device by the boot priority-order information.

If the user presses the power button 14 to power on the computer 10, the system BIOS refers to the boot priority-order information (step S31). The system BIOS determines the boot device with the highest priority (the partition in the HDD 28 that is associated with OS#1) to be the boot device that is to be used, in accordance with the boot priority-order information, and confirms whether the operating system (OS#1) can be booted up from the determined boot device (steps S32 to S34).

If the boot device, which has been confirmed by the system BIOS, is not bootable (NO in step S34), the system BIOS goes to the process in step S17 in FIG. 4.

If the boot device, which has been confirmed by the system BIOS, is bootable (YES in step S34), the system BIOS refers to the flag of the assigned information corresponding to OS#1, and determines whether the assigned information, which corresponds to OS#1, is effective or not, that is, whether the reproduction function of the content data corresponding to OS#1 is effective or not (step S35, S36).

If the reproduction function is effective (YES in step S36), the system BIOS reproduces the content data corresponding to OS#1, which is designated by the assigned information (step S37). On the other hand, if the reproduction function is non-effective (NO in step S36), the process in step S37 is skipped.

Thereafter, the system BIOS executes the boot process for booting up OS#1 from the HDD 28 (step S38).

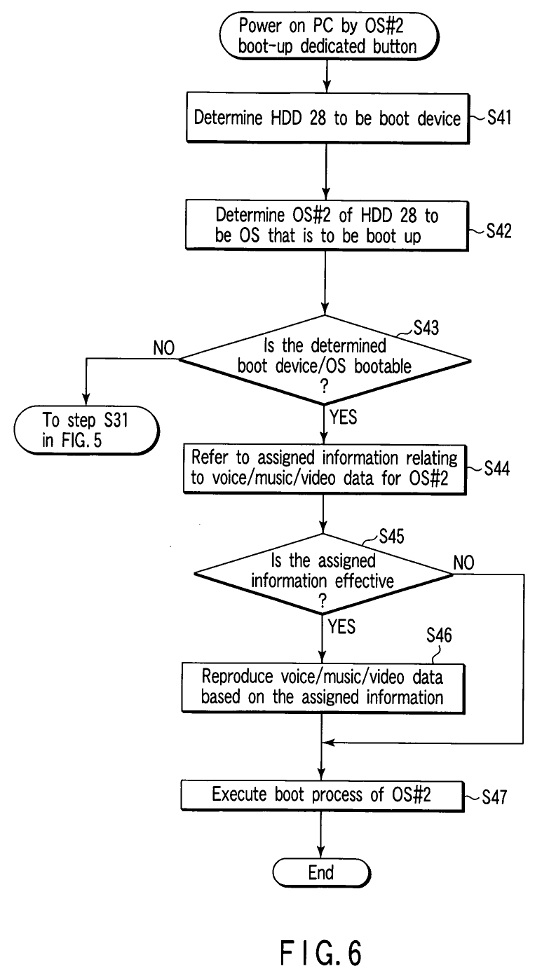

Next, referring to a flow chart of FIG. 6, a process procedure corresponding to the case where OS#2 is booted up is described.

Assume now that the user has pressed the OS#2 boot-up dedicated button.

If the user presses the OS#2 boot-up dedicated button to power on the computer 10, the system BIOS determines the partition in the HDD 28 that is associated with OS#2 to be the boot device that is to be used, while ignoring the boot priority-order information, and confirms whether the operating system (OS#2) can be booted up from the determined boot device (steps S41 to S43).

If the boot device, which has been confirmed by the system BIOS, is not bootable (NO in step S43), the system BIOS goes to the process in step S31 in FIG. 5.

If the boot device, which has been confirmed by the system BIOS, is bootable (YES in step S43), the system BIOS refers to the flag of the assigned information corresponding to OS#2, and determines whether the assigned information, which corresponds to OS#2, is effective or not, that is, whether the reproduction function of the content data corresponding to OS#2 is effective or not (step S44, S45).

If the reproduction function is effective (YES in step S45), the system BIOS reproduces the content data corresponding to OS#2, which is designated by the assigned information (step S46). On the other hand, if the reproduction function is non-effective (NO in step S45), the process in step S46 is skipped.

Thereafter, the system BIOS executes the boot process for booting up OS#2 from the HDD 28 (step S47).

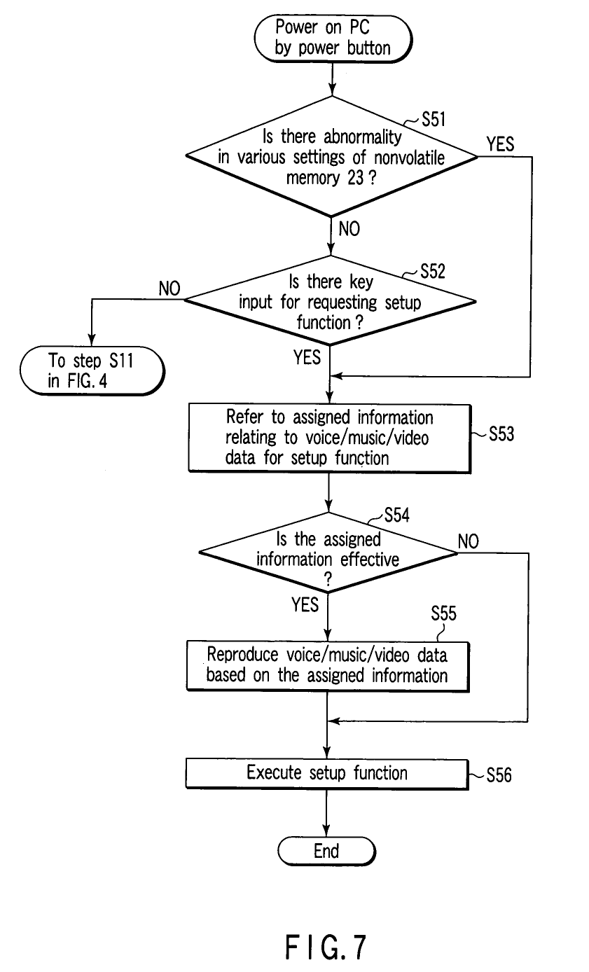

Next, referring to a flow chart of FIG. 7, a process procedure corresponding to the case where the BIOS setup function is activated is described.

If the user presses the power button 14 to power on the computer 10, the system BIOS checks setup information that is stored in the nonvolatile memory 23, and determines whether such abnormality as to cause a problem in boot-up of the computer 10 occurs in the setup information (step S51).

If no such abnormality occurs (NO in step S51), the system BIOS determines whether a specified key input for activating the setup function is made during the POST process (step S52).

If the specified key input is not made (NO in step S52), the system BIOS goes to the process in step S11 in FIG. 4.

On the other hand, if the specified key input is made (YES in step S52) or abnormality in the setup information is detected (YES in step S51), the system BIOS refers to the flag of the assigned information corresponding to the setup function, and determines whether the assigned information, which corresponds to the setup function, is effective or not, that is, whether the reproduction function of the content data corresponding to the setup function is effective or not (step S53, S54).

If the reproduction function is effective (YES in step S54), the system BIOS reproduces the content data corresponding to the setup function, which is designated by the assigned information (step S55). On the other hand, if the reproduction function is non-effective (NO in step S54), the process in step S55 is skipped.

Thereafter, the system BIOS executes the setup function and causes the LCD 17 to display the screen for setting/changing the setup information (step S56).

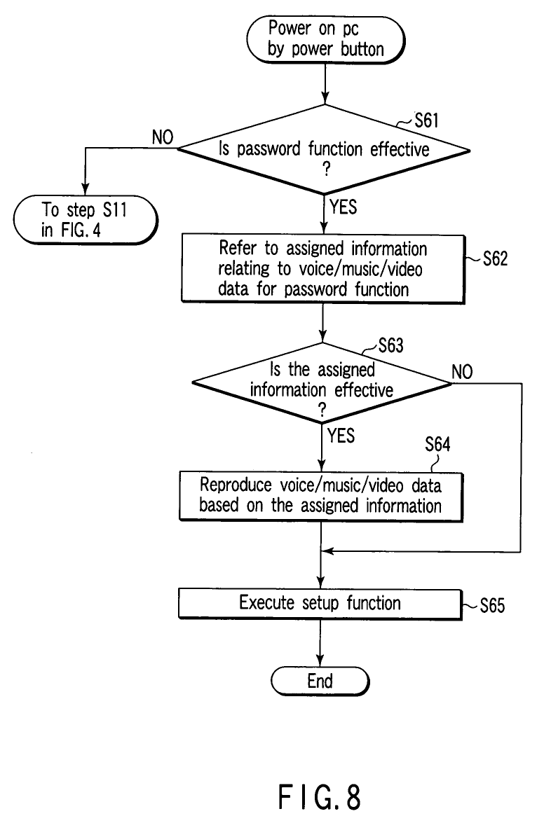

Next, referring to a flow chart of FIG. 8, a process procedure corresponding to the case where the BIOS password check function is activated is described.

If the user presses the power button 14 to power on the computer 10, the system BIOS determines whether the password check function is effective or not, by referring to the setup information that is stored in the nonvolatile memory 23 (step S61). If the password check function is not effective (NO in step S61), the system BIOS goes to the process in step S11 in FIG. 4.

On the other hand, if the password check function is effective (YES in step S61), the system BIOS refers to the flag of the assigned information corresponding to the password check function, and determines whether the assigned information, which corresponds to the password check function, is effective or not, that is, whether the reproduction function of the content data corresponding to the password check function is effective or not (step S62, S63).

If the reproduction function is effective (YES in step S63), the system BIOS reproduces the content data corresponding to the password check function, which is designated by the assigned information (step S64). On the other hand, if the reproduction function is non-effective (NO in step S63), the process in step S64 is skipped.

Thereafter, the system BIOS executes the password check function and causes the LCD 17 to display the password input screen, thus prompting the user to input the password (step S65).

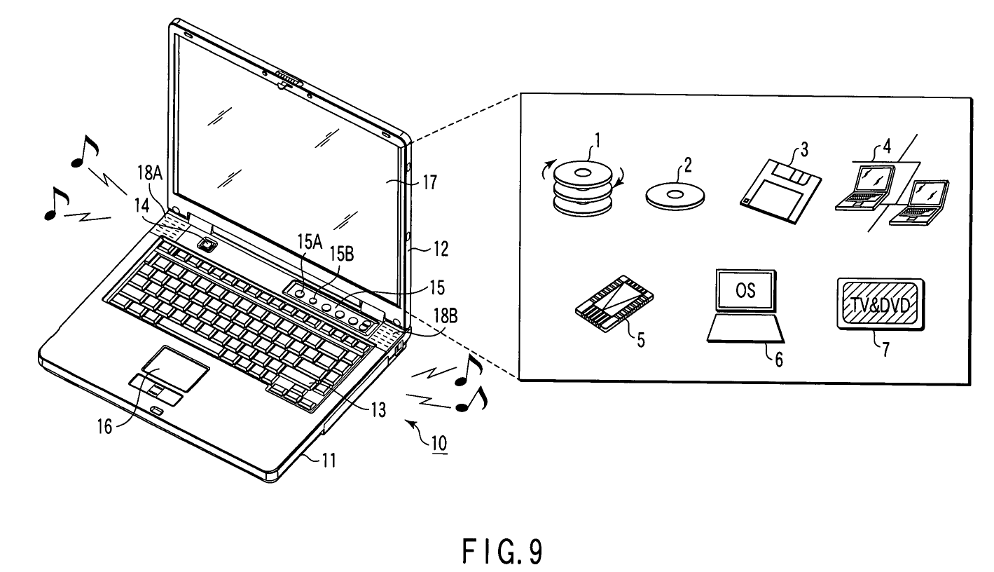

FIG. 9 shows an example of display of image data that identify the respective boot devices.

Assume now that the display screen of the LCD 17 displays, at the same time, still images corresponding to a plurality of motion video data that identify a plurality of boot devices, and reproduction of only the motion video data that identifies the selected boot device is started.

In FIG. 9, reference numeral 1 denotes motion video data that identifies the HDD, numeral 2 motion video data that identifies the ODD, numeral 3 motion video data that identifies the FDD, numeral 4 motion video data that identifies the LAN, numeral 5 motion video data that identifies the memory card, numeral 6 motion video data that identifies the HDD OS#1, and numeral 7 motion video data that identifies the HDD OS#2. The motion video data that identifies the HDD is displayed, for example, when only one OS is installed in the HDD.

The motion video data 1 corresponding to the HDD 28 is composed of video that represents the shape of the HDD. When the HDD 28 is selected as the boot device, reproduction of motion video data 1 (e.g. animation) that is indicative of the shape of the HDD is started and the motion video that is indicative of the shape of the HDD begins to move (e.g. rotation, flickering or change of color of video). If there is audio data corresponding to the HDD 28, reproduction of the audio data is also started at the same as the reproduction of motion video. A sound corresponding to the audio data is produced from the speakers 18A, 18B.

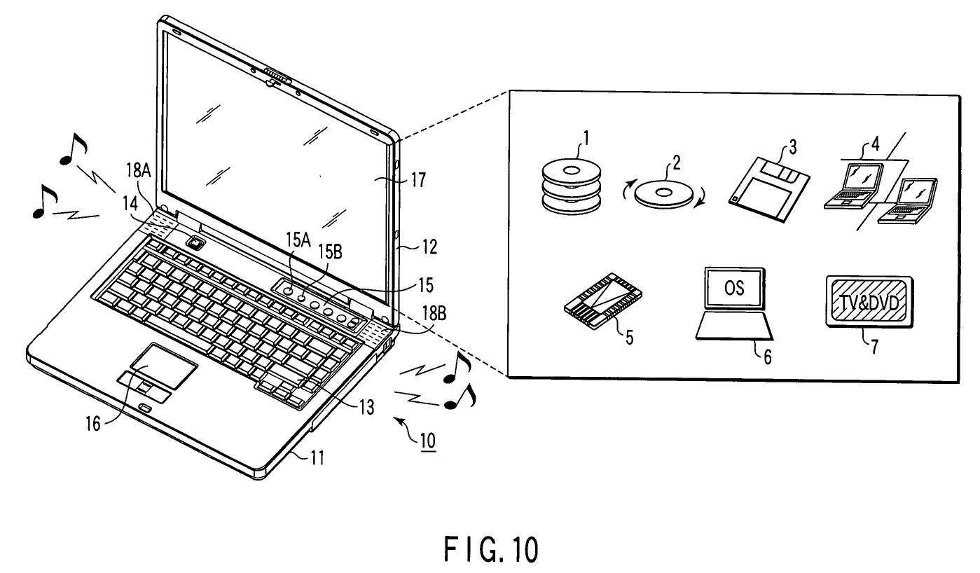

FIG. 10 shows an example of screen display in a case where the ODD 29 is selected as the boot device. The motion video data 2 corresponding to the ODD 29 is composed of video that represents the shape of optical media such as a CD/DVD. When the ODD 29 is selected as the boot device, reproduction of motion video (e.g. animation) that is indicative of the shape of the optical media is started, and the motion video that is indicative of the shape of the optical media begins to move (e.g. rotation, flickering or change of color of video). If there is audio data corresponding to the ODD 29, reproduction of the audio data is also started at the same as the reproduction of motion video. In addition, a sound corresponding to the audio data is produced from the speakers 18A, 18B.

As regards the other motion video data 3 to 7, motion video is reproduced when the associated boot device is selected.

As has been described above, in the state in which the still images of the motion video data corresponding to a plurality of boot devices are displayed on the display screen at the same time, reproduction of only the motion video data that identifies the selected boot device is executed. Thereby, the user can be informed of the kinds of all boot devices that are mounted in the computer 10, and as to from which one of the boot devices the operating system is to be booted up.

Needless to say, it is not necessary to display at the same time the still images of the motion video data corresponding to the boot devices. Only video data corresponding to the selected boot device may be reproduced independently.

According to the embodiments of the invention as described above, the reproduction of content data that identifies the boot device, from which the operating system is to be booted up, is automatically executed during the POST process that is executed by the BIOS. Thus, the user can be informed as to from which boot device the operating system is to be booted up.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An information processing apparatus comprising:
a main body;
an input device that is provided on the main body and inputs input data that designates one of a plurality of boot devices;
means for reproducing data for identifying the boot device that is designated by the input data; and
means for executing a process for booting up an operating system from the boot device that is designated by the input data.

2. The information processing apparatus according to claim 1, wherein the data for identifying the boot device includes at least one of audio data and video data.

3. The information processing apparatus according to claim 1, wherein the reproducing means includes means for determining the data for identifying the boot device that is designated by the input data, based on control information that is indicative of a relationship between the plurality of boot devices and a plurality of data for identifying the plurality of boot devices.

4. The information processing apparatus according to claim 1, further comprising:
means for determining whether the boot device that is designated by the input data is capable of booting up the operating system; and
means for selecting, when the boot device that is designated by the input data is incapable of booting up the operating system, one of the plurality of boot devices, which is capable of booting up the operating system, based on boot priority-order information,
wherein the reproducing means includes means for reproducing data that identifies the selected boot device in a case where the boot device that is designated by the input data is incapable of booting up the operating system.

5. The information processing apparatus according to claim 1, wherein the plurality of boot devices include a first boot device in which a main operating system capable of executing a plurality of application programs is installed, and a second boot device in which a sub-operating system for executing an application program that processes video data, without booting up the main operating system, is installed.

6. The information processing apparatus according to claim 1, wherein the reproducing means includes means for reproducing data that identifies a setup function, in a case where the input data designates a setup function that is executed by a BIOS.

7. The information processing apparatus according to claim 1, wherein the reproducing means includes means for reproducing data that identifies a password check function, in a case where the password check function is executed by a BIOS in response to power-on of the information processing apparatus.

8. A boot control method for booting up an operating system from one of a plurality of boot devices, the method comprising:
inputting input data that designates one of a plurality of boot devices, in accordance with an operation of an input device that is provided on the information processing apparatus;
reproducing data for identifying the boot device that is designated by the input data; and
executing a process for booting up an operating system from the boot device that is designated by the input data.

9. The boot control method according to claim 8, wherein the reproduced data includes at least one of audio data and video data.

10. The boot control method according to claim 8, wherein said reproducing includes determining the data for identifying the boot device that is designated by the input data, based on control information that is indicative of a relationship between the plurality of boot devices and a plurality of data that identify the plurality of boot devices.

11. The boot control method according to claim 8, further comprising:
determining whether the boot device that is designated by the input data is capable of booting up the operating system; and
selecting, when the boot device that is designated by the input data is incapable of booting up the operating system, one of the plurality of boot devices, which is capable of booting up the operating system, based on boot priority-order information,
wherein said reproducing includes reproducing data that identifies the selected boot device in a case where the boot device that is designated by the input data is incapable of booting up the operating system.

12. The boot control method according to claim 8, wherein the plurality of boot devices include a first boot device in which a main operating system capable of executing a plurality of application programs is installed, and a second boot device in which a sub-operating system for executing an application program that processes video data, without booting up the main operating system, is installed.

13. An information processing apparatus comprising:
a main body;
an input device that is provided on the main body and inputs input data that designates one of a plurality of boot devices;
means for reproducing motion video data for identifying the boot device that is designated by the input data from the input device;
a display unit that displays the motion video data that is reproduced by the reproducing means; and
means for executing a process for booting up an operating system from the boot device that is designated by the input data.

14. The information processing apparatus according to claim 13, wherein the reproducing means includes means for reproducing audio data for identifying the boot device that is designated by the input data, and
the information processing apparatus further comprises a speaker that outputs the audio data reproduced by the means for reproducing audio data.

15. The information processing apparatus according to claim 13, further comprising:
means for determining whether the boot device that is designated by the input data is capable of booting up the operating system; and
means for selecting, when the boot device that is designated by the input data is incapable of booting up the operating system, one of the plurality of boot devices, which is capable of booting up the operating system, based on boot priority-order information,
wherein the reproducing means includes means for reproducing motion video data that identifies the selected boot device in a case where the boot device that is designated by the input data is incapable of booting up the operating system.

16. The information processing apparatus according to claim 13, wherein the plurality of boot devices include a first boot device in which a main operating system capable of executing a plurality of application programs is installed, and a second boot device in which a sub-operating system for executing an application program that processes video data, without booting up the main operating system, is installed.
